(19) United States
(12) Patent Application Publication
(10) Pub. No.: US 2019/0313322 A1
(43) Pub. Date: Oct. 10, 2019

(54) METHOD FOR ACQUIRING SYSTEM INFORMATION AND DEVICE SUPPORTING THE SAME

(71) Applicant: LG ELECTRONICS INC., Seoul (KR)

(72) Inventors: Oanyong LEE, Seoul (KR); Youngdae LEE, Seoul (KR)

(73) Assignee: LG ELECTRONICS INC., Seoul (KR)

(21) Appl. No.: 16/375,702

(22) Filed: Apr. 4, 2019

(30) Foreign Application Priority Data
Apr. 5, 2018 (KR) 10-2018-0040012

(51) Int. Cl. H04W 48/12; H04W 48/16; H04W 68/00; H04W 72/04

(52) U.S. Cl. CPC H04W 48/12; H04W 48/16; H04W 76/27; H04W 72/042; H04W 68/005

(57) ABSTRACT

Provided are a method of acquiring system information and a device supporting the method. According to one embodiment of the present invention, the method includes: acquiring first system information including information element (IE) at a first time point; and acquiring validity time information informs how long the IE has not been changed, wherein acquiring of second system information including the IE at a second time point is skipped based on the first time point and the validity time information.

### CROSS-REFERENCE TO RELATED APPLICATIONS

Pursuant to 35 U.S.C. § 119 (e), this application claims the benefit of earlier filing date and right of priority to Korean Patent Application No. 10-2018-0040012, filed on Apr. 5, 2018, the contents of which are hereby incorporated by reference herein in its entirety.

### BACKGROUND OF THE INVENTION

### Field of the Invention

The present invention relates to a wireless communication system, and more particularly, to a method for acquiring system information and a device supporting the same.

### Related Art

Efforts have been made to develop an improved 5th-generation (5G) communication system or a pre-5G communication system in order to satisfy a growing demand on radio data traffic after commercialization of a 4^{th}-generation (4G) communication system. A standardization act for a 5G mobile communication standard work has been formally started in 3GPP, and there is ongoing discussion in a standardization working group under a tentative name of a new radio access (NR).

Meanwhile, an upper layer protocol defines a protocol state to consistently manage an operational state of a user equipment (UE), and indicates a function and procedure of the UE in detail. In the discussion on the NR standardization, an RRC state is discussed such that an RRC_CONNECTED state and an RRC_IDLE state are basically defined, and an RRC_INACTIVE state is additionally introduced.

In the LTE network, when system information is changed, it first notifies the UE about the change via paging message and this notification may be done throughout a modification period. In the next modification period, the network transmits the updated system information. If the i.e. systemInfoModification is set TRUE in paging message, the UE knows that the system information will change at the next modification period boundary.

### SUMMARY OF THE INVENTION

According to a prior art, the UE need to acquire the whole MIB which includes unnecessary information for the UE.

According to an embodiment of the present invention, a method performed by a user equipment (UE) in a wireless communication system is provided. The method may comprise: acquiring first system information including information element (IE) at a first time point; and acquiring validity time information informs how long the IE has not been changed, wherein acquiring of second system information including the IE at a second time point is skipped based on the first time point and the validity time information.

The validity time information may be received via physical downlink control channel (PDCCH).

The PDCCH may be addressed to a paging radio network temporary identifier (P-RNTI).

The acquiring of second system information including the IE at a second time point may be skipped, when duration between the first time point and a current time point is equivalent to the validity time information.

The acquiring of second system information including the IE at a second time point may be performed, when duration between the first time point and a current time point is longer than the validity time information.

The validity time information may be configured per the IE.

The validity time information may inform how long the IE has not been changed by time unit.

According to another embodiment of the present invention, a user equipment (UE) in a wireless communication system is provided. The UE may comprise: a memory; a transceiver; and a processor, operably coupled to the memory and the transceiver, and configured to: acquire first system information including information element (IE) at a first time point; and acquire validity time information informs how long the IE has not been changed, wherein acquiring of second system information including the IE at a second time point is skipped based on the first time point and the validity time information.

The validity time information may be received via physical downlink control channel (PDCCH).

The PDCCH may be addressed to a paging radio network temporary identifier (P-RNTI).

The acquiring of second system information including the IE at a second time point may be skipped, when duration between the first time point and a current time point is equivalent to the validity time information.

The acquiring of second system information including the IE at a second time point may be performed, when duration between the first time point and a current time point is longer than the validity time information.

The validity time information may be configured per the IE.

The validity time information may inform how long the IE has not been changed by time unit.

According to another embodiment of the present invention, a processor for a wireless communication device in a wireless communication system is provided. The processor may be configured to control the wireless communication device to: acquire first system information including information element (IE) at a first time point; and acquire validity time information informs how long the IE has not been changed, wherein acquiring of second system information including the IE at a second time point is skipped based on the first time point and the validity time information.

### BRIEF DESCRIPTION OF THE DRAWINGS

FIG. 1 shows an example of a wireless communication system to which technical features of the present invention can be applied.

FIG. 2 shows another example of a wireless communication system to which technical features of the present invention can be applied.

FIG. 3 shows a block diagram of a user plane protocol stack to which technical features of the present invention can be applied.

FIG. 4 shows a block diagram of a control plane protocol stack to which technical features of the present invention can be applied.

FIG. 5 shows an update of system information.

FIG. 6 shows a method for acquiring system information according to an embodiment of the present invention.

FIG. 7 shows a method for acquiring system information according to an embodiment of the present invention.

FIG. 8 shows an example of acquiring system information according to an embodiment of the present invention.

FIG. 9 shows a UE to implement an embodiment of the present invention.

FIG. 10 shows more detailed UE to implement an embodiment of the present invention. The present invention described above for UE side may be applied to this embodiment.

### DESCRIPTION OF EXEMPLARY EMBODIMENTS

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (DL). For example, only OFDMA may be used for DL and only SC-FDMA may be used for UL. Alternatively, OFDMA and SC-FDMA may be used for DL and/or UL.

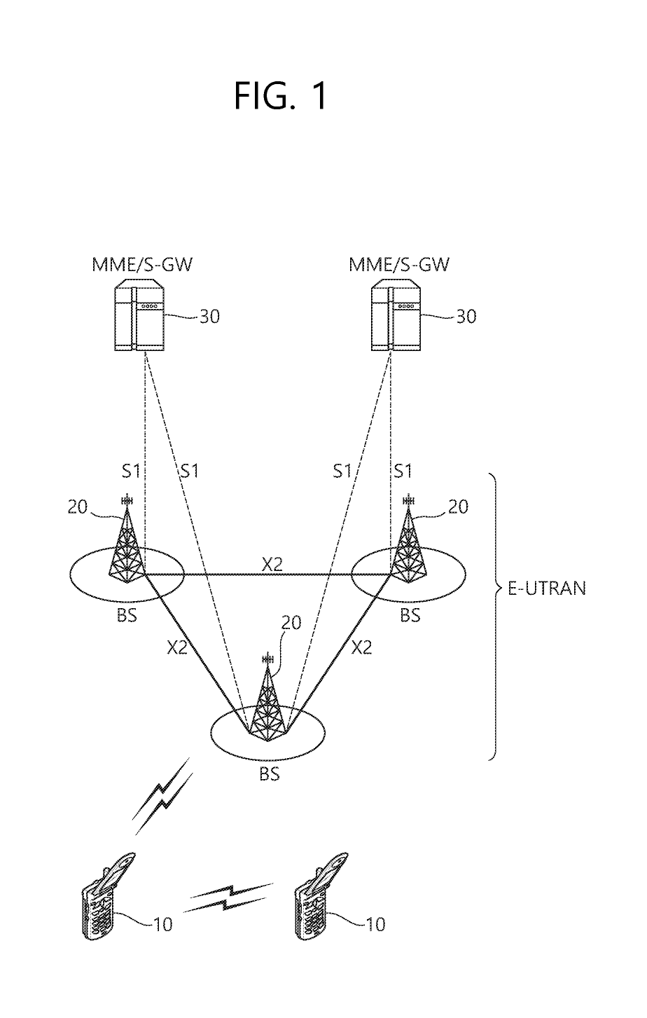

FIG. 1 shows an example of a wireless communication system to which technical features of the present invention can be applied. Specifically, FIG. 1 shows a system architecture based on an evolved-UMTS terrestrial radio access network (E-UTRAN). The aforementioned LTE is a part of an evolved-UTMS (e-UMTS) using the E-UTRAN.

Referring to FIG. 1, the wireless communication system includes one or more user equipment (UE; 10), an E-UTRAN and an evolved packet core (EPC). The UE 10 refers to a communication equipment carried by a user. The UE 10 may be fixed or mobile. The UE 10 may be referred to as another terminology, such as a mobile station (MS), a user terminal (UT), a subscriber station (SS), a wireless device, etc.

The E-UTRAN consists of one or more base station (BS) 20. The BS 20 provides the E-UTRA user plane and control plane protocol terminations towards the UE 10. The BS 20 is generally a fixed station that communicates with the UE 10. The BS 20 hosts the functions, such as inter-cell radio resource management (MME), radio bearer (RB) control, connection mobility control, radio admission control, measurement configuration/provision, dynamic resource allocation (scheduler), etc. The BS may be referred to as another terminology, such as an evolved NodeB (eNB), a base transceiver system (BTS), an access point (AP), etc.

A downlink (DL) denotes communication from the BS 20 to the UE 10. An uplink (UL) denotes communication from the UE 10 to the BS 20. A sidelink (SL) denotes communication between the UEs 10. In the DL, a transmitter may be a part of the BS 20, and a receiver may be a part of the UE 10. In the UL, the transmitter may be a part of the UE 10, and the receiver may be a part of the BS 20. In the SL, the transmitter and receiver may be a part of the UE 10.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 30 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 10 is connected to the BS 20 by means of the Uu interface. The UEs 10 are interconnected with each other by means of the PC5 interface. The BSs 20 are interconnected with each other by means of the X2 interface. The BSs 20 are also connected by means of the S1 interface to the EPC, more specifically to the MME by means of the S1-MME interface and to the S-GW by means of the S1-U interface. The S1 interface supports a many-to-many relation between MMEs/S-GWs and BSs.

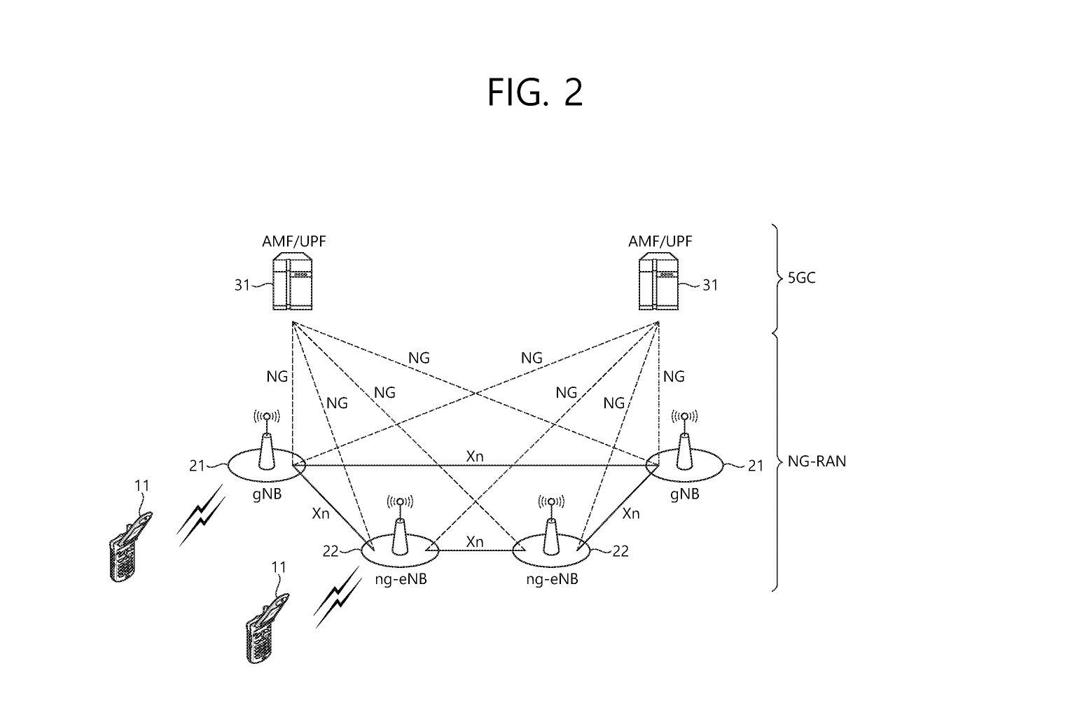

FIG. 2 shows another example of a wireless communication system to which technical features of the present invention can be applied. Specifically, FIG. 2 shows a system architecture based on a 5G new radio access technology (NR) system. The entity used in the 5G NR system (hereinafter, simply referred to as “NR”) may absorb some or all of the functions of the entities introduced in FIG. 1 (e.g. eNB, MME, S-GW). The entity used in the NR system may be identified by the name “NG” for distinction from the LTE/LTE-A.

Referring to FIG. 2, the wireless communication system includes one or more UE 11, a next-generation RAN (NG-RAN) and a 5th generation core network (5GC). The NG-RAN consists of at least one NG-RAN node. The NG-RAN node is an entity corresponding to the BS 10 shown in FIG. 1. The NG-RAN node consists of at least one gNB 21 and/or at least one ng-eNB 22. The gNB 21 provides NR user plane and control plane protocol terminations towards the UE 11. The ng-eNB 22 provides E-UTRA user plane and control plane protocol terminations towards the UE 11.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, protocol data unit (PDU) handling. The UPF an entity including the functions of the conventional S-GW. The SMF hosts the functions, such as UE IP address allocation, PDU session control.

The gNBs and ng-eNBs are interconnected with each other by means of the Xn interface. The gNBs and ng-eNBs are also connected by means of the NG interfaces to the 5GC, more specifically to the AMF by means of the NG-C interface and to the UPF by means of the NG-U interface.

A protocol structure between network entities described above is described. On the system of FIG. 1 and/or FIG. 2, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

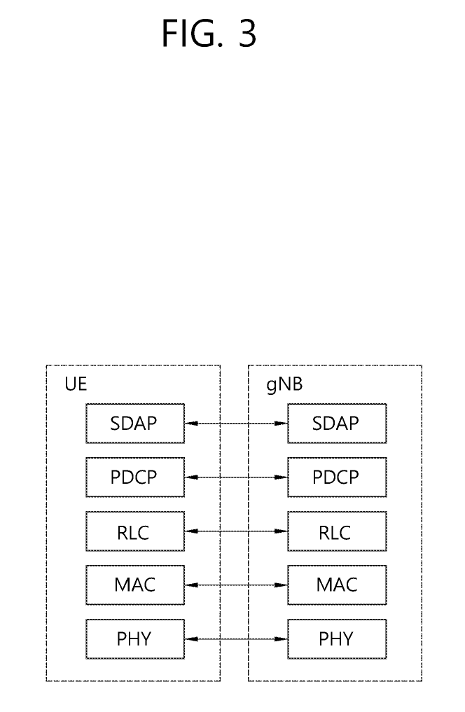

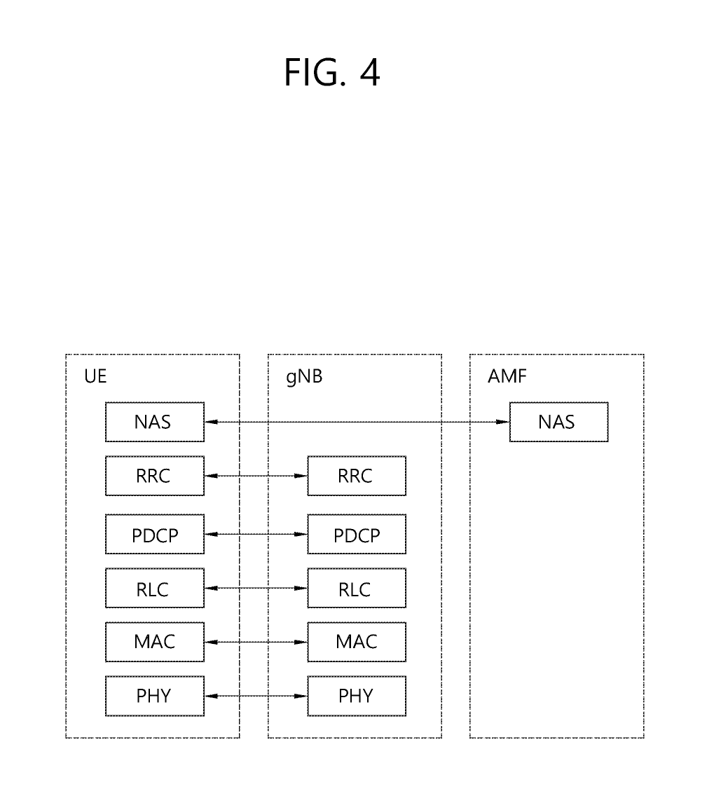

FIG. 3 shows a block diagram of a user plane protocol stack to which technical features of the present invention can be applied. FIG. 4 shows a block diagram of a control plane protocol stack to which technical features of the present invention can be applied. The user/control plane protocol stacks shown in FIG. 3 and FIG. 4 are used in NR. However, user/control plane protocol stacks shown in FIG. 3 and FIG. 4 may be used in LTE/LTE-A without loss of generality, by replacing gNB/AMF with eNB/MME.

Referring to FIG. 3 and FIG. 4, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARQ), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the base station.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel. A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell.

Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL.

Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

System information is described.

An LTE cell broadcasts basic parameters necessary for the operation of an IDLE_MODE UE and a CONNECTED_MODE UE via a plurality of separate information blocks. Examples of information blocks include an MIB, SIB1, SIB2, and other SIBs (SIBn).

The MIB includes the most essential parameters needed for a UE to access a cell. MIB message is broadcast through a BCH according to a periodicity of 40 ms, and MIB transmission is repeated in all radio frames within the periodicity of 40 ms. The UE receives an SIB message using the parameters received via the MIB.

There are different types of SIBs.

SIB1 includes pieces of information associated with cell access, and particularly includes scheduling information on other SIBs (SIB2 to SIBn) than SIB1. SIBs having the same transmission periodicity among the SIBs other than SIB1 are transferred via the same system information (SI) message. Thus, scheduling information includes a mapping relationship between each SIB and an SI message. An SI message is transmitted within an SI window in a time domain, and each SI message is associated with one SI window. Since SI windows for different pieces of SI do not overlap, only one SI message is transmitted within an SI window. Thus, scheduling information includes the duration of an SI window and an SI transmission periodicity. Time/frequency for transmitting an SI message is determined by dynamic scheduling by a BS. SIB1 is broadcast through a downlink shared channel (DL SCH) according to a periodicity of eight radio frames (that is, 80-ms periodicity), and SIB1 is repeatedly retransmitted on a fifth subframe of an SFN-mod-2 radio frame within the 80-ms periodicity.

SIB2 includes necessary information for a UE to access a cell. SIB2 includes information on an uplink cell bandwidth, a random access parameter, and an uplink power control parameter.

SIB3 includes cell reselection information. SIB4 includes frequency information on a serving cell and intra-frequency information on a neighboring cell for cell reselection. SIB5 includes frequency information on a different E-UTRA and inter-frequency information on a neighboring cell for cell reselection. SIB6 includes frequency information on a UTRA and information on a UTRA neighboring cell for cell reselection. SIB7 includes frequency information on a GERAN for cell reselection. SIB8 includes information on a neighboring cell.

SIB9 includes a Home eNodeB (HeNB) identifier (ID). SIB10 to SIB12 include a public warning message, for example, for earthquake warning. SIB14 is used to support enhanced access barring and controls UEs to access a cell. SIB15 includes information needed to receive an MBMS at contiguous carrier frequencies. SIB16 include GPS time and coordinated universal time (UTC)-related information. SIB17 includes RAN auxiliary information.

Not all SIBs are always required to be present. For example, SIB9 is not needed in a mode where a wireless carrier establishes an HeNB, while SIB13 is not needed if a cell provides no MBMS.

System information is commonly applied to all UEs accessing a cell, and UEs need to always maintain up-to-date system information to perform an appropriate operation. When system information is changed, UEs need to know in advance the time the BS transmits new system information. In order that a BS and a UE mutually recognize a radio frame period for transmitting new system information, the concept of BCCH modification period is described in detail.

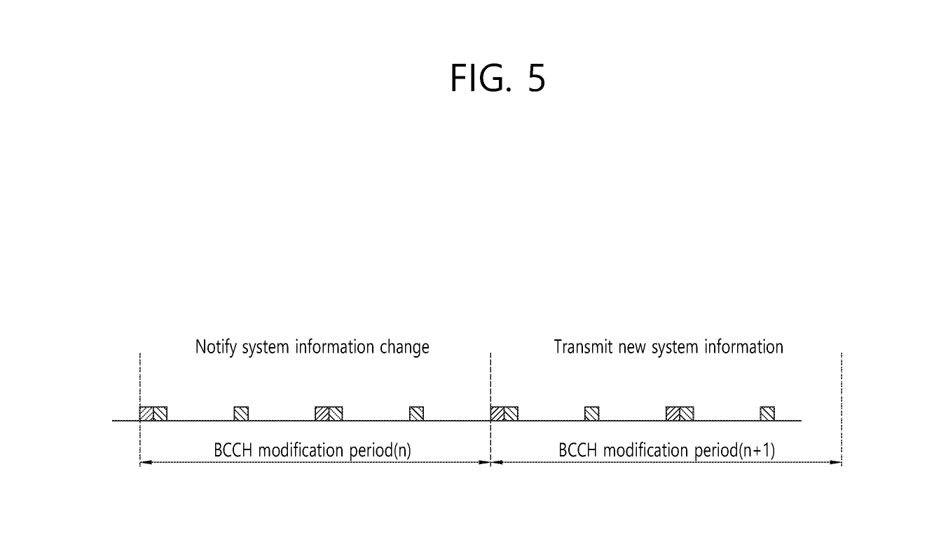

FIG. 5 shows an update of system information.

Referring to FIG. 5, a BS, which intends to update system information in an (n+1)th modification period, notifies in advance UEs of an update of system information in an nth modification period. A UE, which is notified the update of the system information in the nth modification period, receives and applies new system information at the very beginning of the (n+1)th modification period. When an update of system information is scheduled, the BS includes a system information modification indicator in a paging message. Generally, a paging message is a message received by an idle-mode UE. However, since an update of system information is notified through a paging message, a connected-mode UE also needs to receive a paging message at times and to identify an update of system information.

In the LTE network, when system information is changed, it first notifies the UE about the change via paging message and this notification may be done throughout a modification period. In the next modification period, the network transmits the updated system information. If the i.e. systemInfoModification is set TRUE in paging message, the UE knows that the system information will change at the next modification period boundary.

The scheduling information of the system information is provided in SIB1. For BL UE or UE in CE, it is provided in SIB1-BR and its scheduling information is included in MIB using 5 bits. So the BL UE or UE in CE needs to acquire MIB and SIB1-BR one by one to realize that the system information, and then acquire the other system information included in SI messages.

However, in this case, the schedulingInfoSIB1-BR is the only field that the UE needs to know among the contents of the MIB. Assuming that schedulingInfoSIB1-BR may not be changed frequently because the schedulingInfoSIB1-BR only informs the number of repetition and TBS size of the SIB1, it will be beneficial to reduce the system information acquisition time if the UE can skip MIB acquisition.

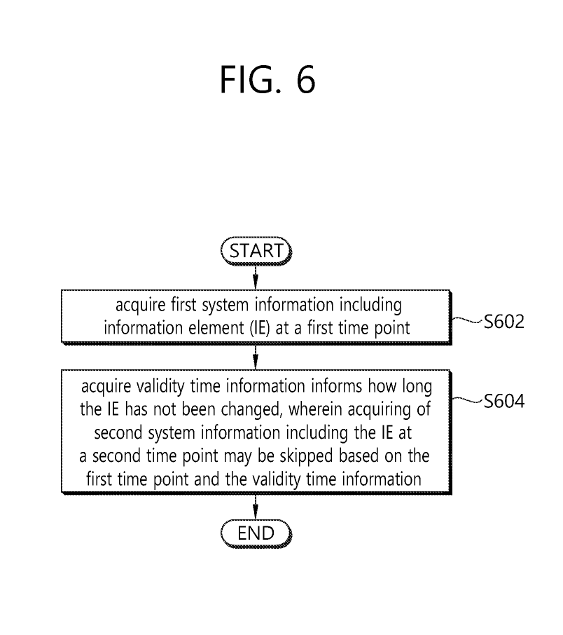

FIG. 6 shows a method for acquiring system information according to an embodiment of the present invention.

In step S602, the UE may acquire first system information including information element (IE) at a first time point.

In step S604, the UE may acquire validity time information informs how long the IE has not been changed. The acquiring of second system information including the IE at a second time point may be skipped based on the first time point and the validity time information. The acquiring of second system information including the IE at a second time point may be skipped, when duration between the first time point and a current time point is equivalent to the validity time information. The acquiring of second system information including the IE at a second time point may be performed, when duration between the first time point and a current time point is longer than the validity time information. The validity time information may be received via physical downlink control channel (PDCCH). The PDCCH may be addressed to a paging radio network temporary identifier (P-RNTI). The validity time information may be configured per the IE. The validity time information may inform how long the IE has not been changed by time unit.

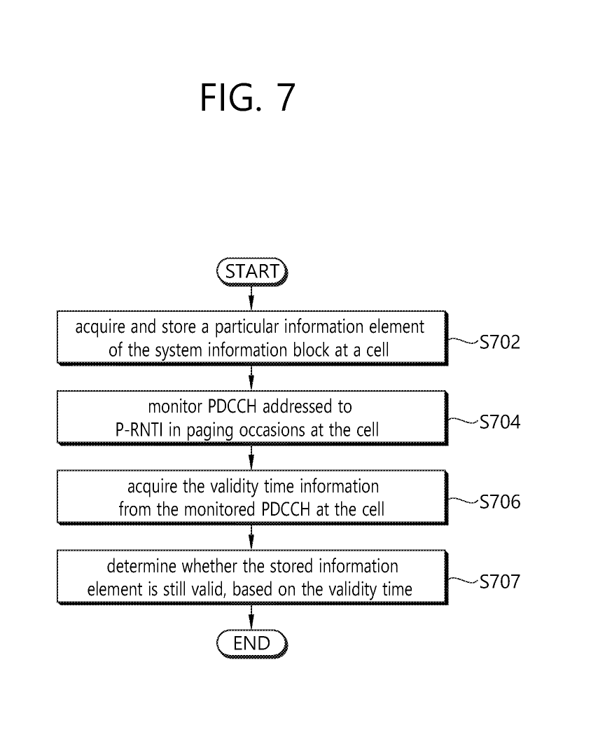

FIG. 7 shows a method for acquiring system information according to an embodiment of the present invention.

In step S702, the UE may acquire and store a particular information element of the system information block at a cell. The system information block may be one of MIB, SIB1, and SIBx (x>1). The UE may consider the information element of the stored system information block as valid. The information element may be one of schedulingInfoSIB1-BR, systemInfoValueTag, systemInfoValueTagSI, etc.

In step S704, the UE may monitor PDCCH addressed to P-RNTI in paging occasions at the cell. The PDCCH may be one of M-PDCCH, N-PDCCH or NR PDCCH. The PDCCH may be used to inform the UE about system information change or scheduling of paging message. The paging occasion may be calculated based on UE's identity.

In step S706, the UE may acquire the validity time information from the monitored PDCCH at the cell. The PDCCH may be addressed to P-RNTI. The PDCCH may include information on the validity time. The validity time may inform how long the current particular information element of the system information block has been valid or how long the particular information element of the system information block will be valid from this moment.

In step S708, based on the validity time, UE may determine whether the stored information element is still valid.

In an embodiment of the present invention, the UE may camp on a first cell and receive system information from the first cell. The system information may include at least one of information element. Then, the UE leaves the first cell, and moves to a second cell. While the UE is camping on the second cell, it may be assumed that the system information received from the first cell is not removed. When the UE comes back to the first cell, the UE need to determine whether the information element in the stored system information is valid or not. Because the UE has information on when the stored system information has been received, the UE may determine whether the information element in the stored system information is valid or not based on the validity time information. Specifically, the UE may determine whether the information element in the stored system information is valid by comparing the time when the stored system information has been received to the validity time information and information.

For example, the UE may come back from a second cell to a first cell. The UE may store system information including information element received from the first cell 5 time units ago. After the UE monitor the PDCCH, it may turn out that currently valid information element has been modified 5 time units ago. In this example, the UE may realize that the information element in the stored system information is still valid, because it means that the stored information element has not been modified after the UE received it.

In step S710, the UE may decode a system information block based on the stored information element without acquisition of the information block in the next modification period, if the monitored PDCCH indicates system information modification in a modification period, and if the stored information element is considered as valid for the next modification period. The system information block may be one of SIB1 and SIBx (x>1).

In step S712, if the monitored PDCCH indicates system information modification in a modification period, and if the stored information element is considered as not valid for the next modification period, UE may re-acquire the information block and decode the system information block based on the information element of the re-acquired information block in the next modification period. The UE may store the information element of the re-acquired information block.

According to embodiments of the present invention, the UE may determine whether the specific field of stored system information is available based on the acquired validity time information, and so the UE may skip the acquiring new system information.

According to an embodiment of the present invention, the validity time may be represented by two types—time based and event based.

Firstly, time based validity time is described. The time based validity time may indicate how much time the current particular information element of the information block has been valid. Supposing that the information element is schedulingInfoSIB1-BR, the validity time may represent how much time the schedulingInfoSIB1-BR has not been changed, in time unit. As the UEs periodically check PDCCH, they can continuously check whether stored schedulingInfoSIB1-BR is valid according to the current value of the validity time. Table 1 shows the meaning of each value of the schedulingInfoSIB1-BR validity time.

TABLE 1

| | The time that |
|---|---|
| Validity time value in | schedulingInfoSIB1-BR has not |
| PDCCH | been changed |
| 0 | 0 |
| 1 | 1 time unit |
| 2 | 2 time units |
| 3 | 3 time units |
| 4 | 4 time units |
| 5 | 5 time units |
| 6 | 6 time units |
| 7 | 7 time units |

In this case, the maximum time unit may be 3 hours (i.e., the maximum hours that the validity time can indicate is 21 hours), because the SI validity time of BL UE or UE in CE is 3 or 24 hours.

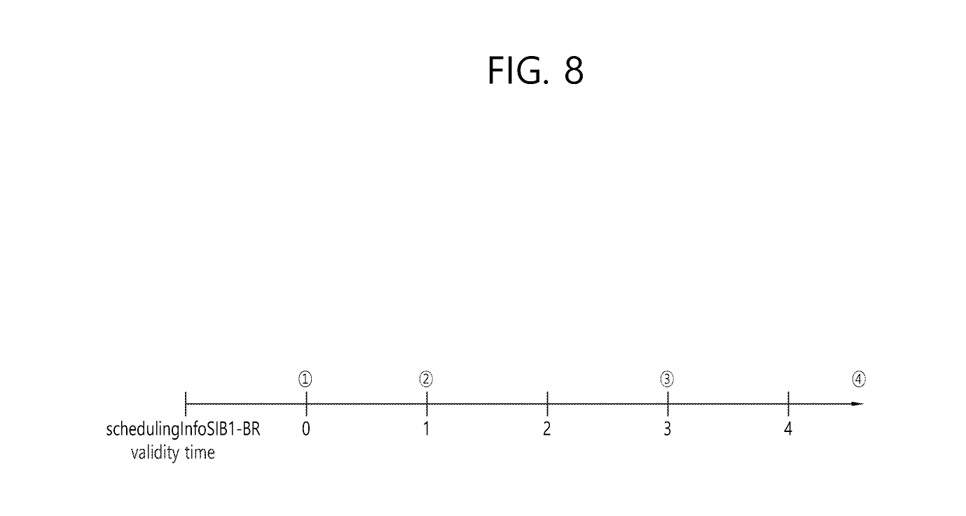

FIG. 8 shows an example of acquiring system information according to an embodiment of the present invention.

Referring to \textcircled{1} of FIG. 8, as soon as schedulingInfoSIB1-BR is changed, the validity time value may be 0. It may mean ‘schedulingInfoSIB1-BR was changed 0 hours ago’. When SI modification occurs while the validity time value is 0, all the UEs may check the schedulingInfoSIB1-BR validity time in PDCCH and then acquire MIB.

At \textcircled{2} of FIG. 8, after a time unit has passed, schedulingInfoSIB1-BR validity time value may become 1. It may mean ‘schedulingInfoSIB1-BR has changed equal to or more than a time unit ago’. While the value is 1, the UEs which have acquired schedulingInfoSIB1-BR between the time point \textcircled{1} and \textcircled{2} may not need to acquire MIB.

At \textcircled{3} of FIG. 8, three time unit has passed after schedulingInfoSIB1-BR was changed. From this step on, the UEs which have acquired schedulingInfoSIB1-BR after the time point \textcircled{1} and \textcircled{2} may not need to acquire MIB.

At \textcircled{4} of FIG. 8, after the schedulingInfoSIB1-BR validity time value may become 7, the value may be no more updated until schedulingInfoSIB1-BR is changed, so all the UEs which have acquired schedulingInfoSIB1-BR after the time point \textcircled{1} may not need to acquire MIB.

Secondly, event based validity time is described.

The event may be at least one of DRX cycle, eDRX cycle, BCCH modification period, etc. The difference with time based validity time may be that the validity time value is not periodically updated, because DRX cycle, eDRX cycle or BCCH modification period is configurable by the network. For another example, the network may want some UEs using DRX cycle to use eDRX cycle. Operation procedure for each update time point of schedulingInfoSIB1-BR validity time is same with time based validity time.

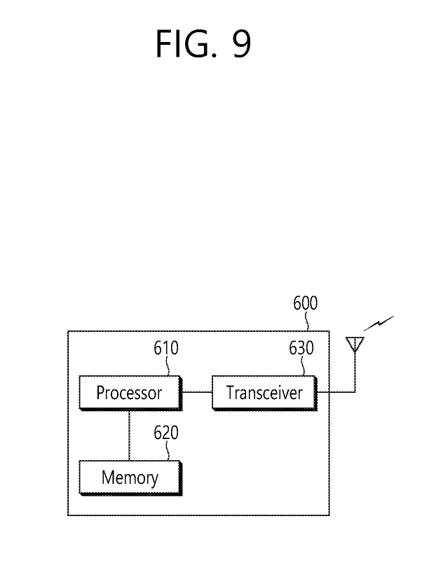

FIG. 9 shows a UE to implement an embodiment of the present invention. The present invention described above for UE side may be applied to this embodiment.

A UE 600 includes a processor 610, a memory 620 and a transceiver 630. The processor 610 may be configured to implement proposed functions, procedures and/or methods described in this description. Layers of the radio interface protocol may be implemented in the processor 610.

Specifically, the processor 610 is configured to acquire first system information including information element (IE) at a first time point.

The processor 610 is configured to acquire validity time information informs how long the IE has not been changed. The acquiring of second system information including the IE at a second time point may be skipped based on the first time point and the validity time information. The acquiring of second system information including the IE at a second time point may be skipped, when duration between the first time point and a current time point is equivalent to the validity time information. The acquiring of second system information including the IE at a second time point may be performed, when duration between the first time point and a current time point is longer than the validity time information. The validity time information may be received via physical downlink control channel (PDCCH). The PDCCH may be addressed to a paging radio network temporary identifier (P-RNTI). The validity time information may be configured per the IE. The validity time information may inform how long the IE has not been changed by time unit.

The memory 620 is operatively coupled with the processor 610 and stores a variety of information to operate the processor 610. The transceiver 630 is operatively coupled with the processor 610, and transmits and/or receives a radio signal.

The processor 610 may include application-specific integrated circuit (ASIC), other chipset, logic circuit and/or data processing device. The memory 620 may include read-only memory (ROM), random access memory (RAM), flash memory, memory card, storage medium and/or other storage device. The transceiver 630 may include baseband circuitry to process radio frequency signals. When the embodiments are implemented in software, the techniques described herein can be implemented with modules (e.g., procedures, functions, and so on) that perform the functions described herein. The modules can be stored in the memory 620 and executed by the processor 610. The memory 620 can be implemented within the processor 610 or external to the processor 610 in which case those can be communicatively coupled to the processor 610 via various means as is known in the art.

According to embodiments of the present invention, the UE may determine whether the specific field of stored system information is available based on the acquired validity time information, and so the UE may skip the acquiring new system information.

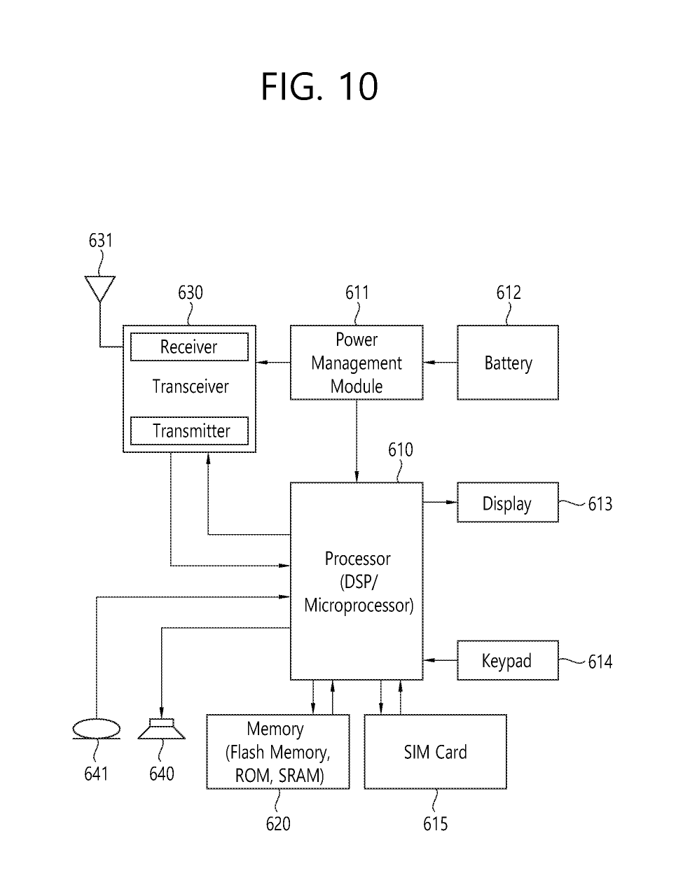

FIG. 10 shows more detailed UE to implement an embodiment of the present invention. The present invention described above for UE side may be applied to this embodiment.

A UE includes a processor 610, a power management module 611, a battery 612, a display 613, a keypad 614, a subscriber identification module (SIM) card 615, a memory 620, a transceiver 630, one or more antennas 631, a speaker 640, and a microphone 641.

The processor 610 may be configured to implement proposed functions, procedures and/or methods described in this description. Layers of the radio interface protocol may be implemented in the processor 610. The processor 610 may include ASIC, other chipset, logic circuit and/or data processing device. The processor 610 may be an application processor (AP).

The processor 610 may include at least one of a digital signal processor (DSP), a central processing unit (CPU), a graphics processing unit (GPU), a modem (modulator and demodulator). An example of the processor 610 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The processor 610 is configured to acquire first system information including information element (IE) at a first time point.

The processor 610 is configured to acquire validity time information informs how long the IE has not been changed. The acquiring of second system information including the IE at a second time point may be skipped based on the first time point and the validity time information. The acquiring of second system information including the IE at a second time point may be skipped, when duration between the first time point and a current time point is equivalent to the validity time information. The acquiring of second system information including the IE at a second time point may be performed, when duration between the first time point and a current time point is longer than the validity time information. The validity time information may be received via physical downlink control channel (PDCCH). The PDCCH may be addressed to a paging radio network temporary identifier (P-RNTI). The validity time information may be configured per the IE. The validity time information may inform how long the IE has not been changed by time unit.

The power management module 611 manages power for the processor 610 and/or the transceiver 630. The battery 612 supplies power to the power management module 611. The display 613 outputs results processed by the processor 610. The keypad 614 receives inputs to be used by the processor 610. The keypad 614 may be shown on the display 613. The SIM card 615 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The memory 620 is operatively coupled with the processor 610 and stores a variety of information to operate the processor 610. The memory 620 may include ROM, RAM, flash memory, memory card, storage medium and/or other storage device. When the embodiments are implemented in software, the techniques described herein can be implemented with modules (e.g., procedures, functions, and so on) that perform the functions described herein. The modules can be stored in the memory 620 and executed by the processor 610. The memory 620 can be implemented within the processor 610 or external to the processor 610 in which case those can be communicatively coupled to the processor 610 via various means as is known in the art.

The transceiver 630 is operatively coupled with the processor 610, and transmits and/or receives a radio signal. The transceiver 630 includes a transmitter and a receiver. The transceiver 630 may include baseband circuitry to process radio frequency signals. The transceiver 630 controls the one or more antennas 631 to transmit and/or receive a radio signal.

The speaker 640 outputs sound-related results processed by the processor 610. The microphone 641 receives sound-related inputs to be used by the processor 610.

According to embodiments of the present invention, the UE may determine whether the specific field of stored system information is available based on the acquired validity time information, and so the UE may skip the acquiring new system information.

In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A, B, C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the appended claims.

What is claimed is:

1. A method performed by a user equipment (UE) in a wireless communication system, the method comprising:
acquiring first system information including information element (IE) at a first time point; and
acquiring validity time information informs how long the IE has not been changed,
wherein acquiring of second system information including the IE at a second time point is skipped based on the first time point and the validity time information.

2. The method of claim 1, wherein the validity time information is received via physical downlink control channel (PDCCH).

3. The method of claim 2, wherein the PDCCH is addressed to a paging radio network temporary identifier (P-RNTI).

4. The method of claim 1, wherein the acquiring of second system information including the IE at a second time point is skipped, when duration between the first time point and a current time point is equivalent to the validity time information.

5. The method of claim 1, wherein the acquiring of second system information including the IE at a second time point is performed, when duration between the first time point and a current time point is longer than the validity time information.

6. The method of claim 1, wherein the validity time information is configured per the IE.

7. The method of claim 1, wherein the validity time information informs how long the IE has not been changed by time unit.

8. A user equipment (UE) in a wireless communication system, the UE comprising:
a memory;
a transceiver; and
a processor, operably coupled to the memory and the transceiver, and configured to:
acquire first system information including information element (IE) at a first time point; and
acquire validity time information informs how long the IE has not been changed,
wherein acquiring of second system information including the IE at a second time point is skipped based on the first time point and the validity time information.

9. The UE of claim 8, wherein the validity time information is received via physical downlink control channel (PDCCH).

10. The UE of claim 9, wherein the PDCCH is addressed to a paging radio network temporary identifier (P-RNTI).

11. The UE of claim 8, wherein the acquiring of second system information including the IE at a second time point is skipped, when duration between the first time point and a current time point is equivalent to the validity time information.

12. The UE of claim 8, wherein the acquiring of second system information including the IE at a second time point is performed, when duration between the first time point and a current time point is longer than the validity time information.

13. The UE of claim 8, wherein the validity time information is configured per the IE.

14. The UE of claim 8, wherein the validity time information informs how long the IE has not been changed by time unit.

15. A processor for a wireless communication device in a wireless communication system,
wherein the processor is configured to control the wireless communication device to:
acquire first system information including information element (IE) at a first time point; and
acquire validity time information informs how long the IE has not been changed,
wherein acquiring of second system information including the IE at a second time point is skipped based on the first time point and the validity time information.
